(19) United States
(12) Patent Application Publication
(10) Pub. No.: US 2026/0107285 A1
(43) Pub. Date: Apr. 16, 2026

(54) CONTROL CHANNEL ELEMENT AGGREGATION ACROSS LINKED SEARCH SPACES

(71) Applicant: Lenovo (United States) Inc., Morrisville, NC (US)

(72) Inventors: Karthikeyan Ganesan, Kronberg Im Taunus (DE); Ali Ramadan Ali, Kraiburg am Inn (DE)

(21) Appl. No.: 19/418,616

(22) Filed: Dec. 12, 2025

(51) Int. Cl. H04W 72/232

(52) U.S. Cl. CPC H04W 72/232

(57) ABSTRACT

Various aspects of the present disclosure relate to configuring linked search spaces for control channel element (CCE) aggregation or multiplexing. A base station can transmit configuration information that indicates an association between a first search space set and a second search space set. Additionally, the base station can transmit a Physical Downlink Control Channel (PDCCH) transmission using a PDCCH. The PDCCH can comprise a plurality of CCEs from the first search space set and the second search space set. Moreover, the base station can transmit an indication of a timing offset between the PDCCH transmission and a corresponding Physical Downlink Shared Channel (PDSCH) transmission.

### TECHNICAL FIELD

The present disclosure relates generally to wireless communication systems, and more specifically to systems and methods for processing (e.g., aggregating, multiplexing, or the like) control channel elements (CCEs).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

The devices (e.g., NE, UE), processors, and methods of the present disclosure each have several innovative aspects, no single one of which is solely responsible for the desirable features disclosed herein.

A NE (e.g., base station) for wireless communication is described. The NE may be configured to, capable of, or operable to perform one or more operations as described herein. For example, the NE may be configured to, capable of, or operable to: transmit configuration information that indicates an association between a first search space set and a second search space set; transmit a Physical Downlink Control Channel (PDCCH) transmission using a PDCCH, wherein the PDCCH can include a plurality of CCEs from the first search space set and the second search space set; and transmit an indication of a timing offset between the PDCCH transmission and a corresponding Physical Downlink Shared Channel (PDSCH) transmission.

In some examples, the PDCCH transmission contains downlink control information (DCI) associated with a selected aggregation level.

In some examples, the configuration information identifies the plurality of CCEs from the first search space set and the second search space set. In some examples, the plurality of CCEs can include a first subset of CCEs from the first search space set and a second subset of CCEs from the second search space set.

In some examples, the association between the first search space set and the second search space set can correspond to an intra-slot aggregation linkage. In some examples, the first search space set and the second search space set are in a same slot (e.g., time slot). In some examples, the timing offset can be set to zero.

In some examples, the association between the first search space set and the second search space set can correspond to an inter-slot aggregation linkage. In some examples, the first search space set and the second search space set can be in different slots. In some examples, the timing offset can be set to an integer number associated with the different slots.

In some examples, the association between the first search space set and the second search space set can correspond to a per-span aggregation linkage. In some examples, the first search space set and second search space set can be within a span of multiple slots. In some examples, the timing offset is associated with a gap between the reception of the first search space and the second search space.

In some examples, the first search space set and the second search space set are associated with a same Control Resource Set (CORESET) identifier. In some examples, the first search space set and the second search space set are associated with a different CORESET identifier.

In some examples, the plurality of CCEs can be determined semi-statically, and wherein the configuration information can be transmitted in a Radio Resource Control (RRC) message. In some examples, the plurality of CCEs can be determined dynamically, and wherein the configuration information is transmitted during the PDCCH transmission.

In some examples, a first CCE from the first search space set and a second CCE from the second search space set are aggregated using a non-interleaved mapping to obtain the plurality of CCEs. In some examples, a first CCE from the first search space set and a second CCE from the second search space set are aggregated using a partial or selective interleaved mapping to obtain the plurality of CCEs for the PDCCH transmission using a selected aggregation level.

In some examples, the plurality of CCEs includes a first CCE from the first search space set and a second CCE from the second search space set. In some examples, DCI is transmitted in the first CCE and in the second CCE, and wherein the DCI is associated with a selected aggregation level.

In some examples, the NE may be configured to, capable of, or operable to transmit an indication of a specific number of PDCCH candidates in a search space.

A processor (e.g., a standalone processor chipset, or a component of a NE) for wireless communication is described. The processor may be configured to, capable of, or operable to perform one or more operations as described herein. For example, the processor may be configured to, capable of, or operable to: transmit configuration information that indicates an association between a first search space set and a second search space set; transmit a PDCCH transmission using a PDCCH, wherein the PDCCH can include a plurality of CCEs from the first search space set and the second search space set; and transmit an indication of a timing offset between the PDCCH transmission and a corresponding PDSCH transmission.

A method performed or performable by a NE for wireless communication is described. The method may include transmitting configuration information that indicates an association between a first search space set and a second search space set; transmitting a PDCCH transmission using a PDCCH, wherein the PDCCH can include a plurality of CCEs from the first search space set and the second search space set; and transmitting an indication of a timing offset between the PDCCH transmission and a corresponding PDSCH transmission.

A UE for wireless communication is described. The UE may be configured to, capable of, or operable to perform one or more operations as described herein. For example, the UE may be configured to, capable of, or operable to: receive configuration information that indicates an association between a first search space set and a second search space set; decode a PDCCH transmission that is received via a PDCCH, wherein the PDCCH can include a plurality of CCEs from the first search space set and the second search space set; receive an indication of a timing offset between the PDCCH transmission and a PDSCH transmission; and decode the PDSCH transmission based on the timing offset.

A processor (e.g., a standalone processor chipset, or a component of a UE) for wireless communication is described. The processor may be configured to, capable of, or operable to perform one or more operations as described herein. For example, the processor may be configured to, capable of, or operable to: receive configuration information that indicates an association between a first search space set and a second search space set; decode a PDCCH transmission that is received via a PDCCH, wherein the PDCCH can include a plurality of CCEs from the first search space set and the second search space set; receive an indication of a timing offset between the PDCCH transmission and a PDSCH transmission; and decode the PDSCH transmission based on the timing offset.

A method performed or performable by a UE for wireless communication is described. The method may include receiving configuration information that indicates an association between a first search space set and a second search space set; decoding a PDCCH transmission that is received via a PDCCH, wherein the PDCCH can include a plurality of CCEs from the first search space set and the second search space set; receiving an indication of a timing offset between the PDCCH transmission and a PDSCH transmission; and decoding the PDSCH transmission based on the timing offset.

In some examples, the PDCCH transmission contains DCI associated with a selected aggregation level.

In some examples, the configuration information identifies the plurality of CCEs from the first search space set and the second search space set. In some examples, the plurality of CCEs includes a first subset of CCEs from the first search space set and a second subset of CCEs from the second search space set.

In some examples, the UE may be configured to, capable of, or operable to: receive an indication of a specific number of PDCCH candidates; and determine a location of a PDCCH candidate for decoding the PDCCH transmission based on using a hash function and the plurality of CCEs.

### BRIEF DESCRIPTION OF THE DRAWINGS

FIG. 1 illustrates an example of a wireless communications system in accordance with aspects of the present disclosure.

FIG. 2 illustrates an example mapping of control resource allocation and signaling flow in accordance with aspects of the present disclosure.

FIG. 3 illustrates a conventional CCE mapping technique in accordance with aspects of the present disclosure.

FIG. 4 illustrates a CCE aggregation technique using a plurality of search spaces in accordance with aspects of the present disclosure.

FIG. 5 illustrates a CCE aggregation technique using a plurality of search spaces in accordance with aspects of the present disclosure.

FIG. 6 illustrates a flowchart of method performed by a NE in accordance with aspects of the present disclosure.

FIG. 7 illustrates a flowchart of method performed by a UE in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of an NE in accordance with aspects of the present disclosure.

### DETAILED DESCRIPTION

The present disclosure relates to wireless communication systems and addresses limitations of control channel resource fragmentation and the timing challenges associated with utilizing control resources from different time intervals. In some wireless communication systems, a transmitting device (e.g., a base station) may transmit a PDCCH transmission (e.g., DCI) on a PDCCH to schedule a receiving device (e.g., UE) for data transmission. The PDCCH can be constructed from CCEs, with the quantity of CCEs determined by an aggregation level that can correspond to channel conditions. A CORESET can be provisioned with a number of CCEs, however, in conventional methods, search spaces can logically separate CORESET resources using monitoring occasions using symbols and slots. A challenge can arise from CCE resource fragmentation, where available CCEs are scattered in one or more blocks (e.g., 1 block, 2 blocks, 3 blocks) across separate search spaces. For example, if a receiving device requires a high aggregation level (e.g., aggregation level determined based on the channel conditions), but no single search space contains enough available CCEs, the PDCCH may not be scheduled. This condition, sometimes referred to as PDCCH blocking, can prevent the receiving device from being scheduled, potentially leading to inefficient use of control channel capacity and delays in data transmission.

Further difficulties may arise when control resources are considered across different time intervals. A receiving device typically decodes the DCI from the PDCCH before attempting to decode corresponding PDSCH transmission on a PDSCH. If CCEs for a single PDCCH are distributed across different slots, a timing desynchronization can occur, where the receiving device may attempt to decode the PDSCH before it has processed all the CCEs from the final slot. This premature decoding attempt may fail, leading to data loss and triggering retransmissions, which consumes processing power and battery life.

To improve the efficiency and reliability of control channel signaling, the base station may be configured to transmit configuration information to a UE. This configuration information can establish an association between a first search space set and a second search space set, designating them for the purpose of CCE aggregation and/or multiplexing. A search space set can define a set of resources in a CORESET where a UE monitors for potential PDCCH transmissions. The PDCCH itself can be constructed from one or more CCEs depending on the selected aggregation level, which are resource units for control information. By creating an association between search space sets, the base station and the UE can be instructed to treat the CCEs contained within these otherwise separate sets as a single, combined resource pool. The configuration information that defines this association may be conveyed through various signaling mechanisms. In some examples, it can be transmitted statically or semi-statically via RRC messaging, which can be suitable for establishing long-term or cell-wide aggregation policies. Alternatively, the configuration can be provided more dynamically, for example, through a Medium Access Control (MAC) Control Element (MAC-CE) or within a DCI itself, allowing for better adaptation to changing network loads and scheduling needs.

The association of the subset of CCEs from first search space and the second search space for CCE aggregation or multiplexing can be configured for various time-domain scenarios to provide scheduling flexibility. In one example, the association corresponds to an intra-slot aggregation linkage. In this scenario, the first search space set and the second search space set can both be located within the same slot. For example, the two search spaces might occupy different, non-overlapping frequency resources (e.g., CCEs) within the slot, or they might be time-division multiplexed on different Orthogonal Frequency-Division Multiplexing (OFDM) symbols within the same slot. This type of aggregation can be useful for combining fragmented CCE resources that exist concurrently, allowing a PDCCH to have a high aggregation level to be scheduled without waiting for a future slot. In another example, the linking corresponds to an inter-slot aggregation linkage. In this scenario, the first search space set can be located in one slot, while the second search space set is located in a different, typically subsequent, slot. This approach can be valuable when sufficient CCEs are not available in any single slot, enabling a scheduler to gather the necessary resources across a limited time interval. A further extension may include a per-span aggregation linkage, where the first and second search space sets are part of a defined span of multiple consecutive slots. For instance, a span could be defined as two, three, or four slots, and the subset of CCEs from all linked search spaces within that span are aggregated.

In some implementations, the association of the first and second search space sets can be associated with a same CORESET. A CORESET can define a common set of time and frequency resources, and associating the linked search spaces with the same CORESET can facilitate that they share a consistent underlying resource configuration, simplifying the aggregation and decoding process for the UE.

Once the plurality of search spaces is associated together, the base station can aggregate the subset of CCEs for a PDCCH transmission using an aggregation level (AL) using one of several methods. In one implementation, a plurality of CCEs for a PDCCH candidate can be aggregated by combining a total pool of CCEs from the first search space set with a total pool of CCEs from the second search space set to form a unified CCE pool. For example, if a first search space has 20 CCEs and a second search space has 20 CCEs, the unified pool would contain 40 CCEs. The base station can then treat this unified pool as a single, larger search space for the purpose of placing PDCCH candidates using a large aggregation level that may not be supported by one search space. In an alternative implementation, the aggregation can be more targeted, combining only the subset of CCEs from the associated search spaces. After a first pass of scheduling, the scheduler may identify remaining subsets of CCE in the first and second search spaces. These subsets of CCEs can form new PDCCH candidates for a UE, thereby utilizing residual resources that might otherwise be unused. Alternatively, the larger aggregation level is formed naturally by combining existing smaller candidates. For example, “Candidate #1 of AL8 in Set A”+“Candidate #1 of AL8 in Set B” automatically combine to form “Candidate #1 of AL16”.

Additionally, the mapping of these aggregated CCEs can also vary. For instance, in a non-interleaved mapping, the CCEs from the first search space can be indexed contiguously, followed by the CCEs from the second search space. Alternatively, an interleaved mapping could be used, where CCEs from the two search spaces are mixed according to a defined pattern, which can provide frequency diversity benefits.

After aggregating the CCEs, the base station may be configured to place PDCCH transmission within this new, larger resource pool, and the UE may be configured to find them. The location of a PDCCH transmission within a search space can be determined by applying a hash function. In the context of CCE aggregation, a modified or unified hash function can be applied to the aggregated plurality of CCEs to determine the location of the PDCCH transmission. The inputs to this hash function can be updated to reflect the properties of the aggregated pool, for example, using the total number of aggregated CCEs as a parameter. To manage the UE's processing load, the base station may also transmit an indication of the number of PDCCH candidates that are available for the UE to search within this aggregated CCE space. This signaling may facilitate that the UE does not perform an excessive number of blind decodes, keeping its computational complexity and power consumption within a pre-defined budget.

An aspect of some implementations can be the management of decoding timelines, especially for inter-slot aggregation. The base station can transmit an indication of a timing offset between the PDCCH transmission and its corresponding PDSCH transmission. When the aggregation is performed inter-slot or per-span, the CCEs constituting a single PDCCH can be spread across multiple slots. The UE may obtain the complete DCI after receiving and processing the CCEs from the final slot in the sequence. For an inter-slot aggregation linkage, the timing offset can be a non-zero value that instructs the UE to delay the start of its PDSCH decoding. The timing offset may facilitate the UE to wait until a point in time after the completion of the last slot containing the aggregated CCEs before attempting to decode the PDSCH, thereby reducing the likelihood of a premature decoding attempt and subsequent data loss. This offset value could be signaled as a specific number of slots or symbols, or as an index into a pre-configured table of offset values. Conversely, for an intra-slot aggregation linkage where all CCEs are within a single slot, additional latency may not be introduced. In this case, the timing offset can be set to zero. A zero offset can indicate to the UE that a standard timing relationship between PDCCH and PDSCH applies, and it may proceed to decode the PDSCH in the same slot or after a minimal, default processing time. Alternatively, PDCCH can be transmitted using an aggregation level by using a subset of CCEs in a plurality of linked search spaces e.g., PDCCH using higher aggregation level can be transmitted using one or more smaller aggregation levels using subset of CCEs in a plurality of linked search spaces

From the perspective of a UE, which may be equipped with one or more processors and one or more memories, a process can begin with receiving the configuration information from the base station that indicates the association between the first and second search space sets for CCE aggregation. The UE can store this configuration and use it to understand which CCE resources should be treated as a single, combined pool. When monitoring for control information, the UE can perform blind decoding on PDCCH transmission that are located within this aggregated resource. To identify candidate locations, the UE can apply the same unified hash function used by the base station, using the parameters of the aggregated CCE pool as input. This may facilitate that the UE searches for candidates in the correct locations within the combined resources of the first and second search spaces.

An operational constraint for the UE can be its blind decoding budget, which limits the number of decoding attempts it can perform in each period to conserve power and manage processing load. One or more aspects of the present disclosure may be configured such that the total number of blind decodes performed by the UE across the linked first and second search space sets does not exceed a configured maximum blind decoding budget. By receiving an indication from the base station about the number of candidates to search for in the aggregated space, the UE may manage its decoding operations to stay within its budget, even while benefiting from the larger CCE pool. Upon successfully decoding a DCI from a PDCCH transmission composed of aggregated CCEs, the UE can also receive and process the indication of the timing offset.

The UE can use this timing offset to schedule the decoding of the associated PDSCH. If the DCI was received via an inter-slot aggregation linkage, the UE may recognize that the PDCCH spanned multiple slots. It may use the non-zero timing offset to determine a start time for PDSCH reception and decoding, to facilitate that it waits until after the completion of the last slot containing the PDCCH CCEs. This may reduce the likelihood of decoding failures that could occur from attempting to process the PDSCH prematurely. If the DCI was received via an intra-slot aggregation linkage, the UE may observe that the timing offset is set to zero. This can inform the UE that the PDSCH can be decoded without additional delay, for example, within the same slot as the PDCCH candidate. By interpreting and applying the timing offset based on the type of CCE aggregation, the UE may achieve more reliable data reception while one or more aspects of the present disclosure may benefit from the increased scheduling flexibility and efficiency of CCE aggregation.

An example technical problem solved by aspects of the present disclosure may include the inefficient utilization of control channel resources in wireless communication systems. A base station can transmit DCI within a PDCCH to schedule a UE. The PDCCH can be constructed from a plurality of CCEs, with the quantity determined by an aggregation level that corresponds to the UE's channel conditions. A problem can arise when the available CCEs are fragmented across multiple, separate search spaces. For instance, a base station may need to schedule a UE requiring an aggregation level of 4, but only 2 CCEs are available in a first search space and 2 CCEs are available in a second search space. Despite a total of 4 CCEs being available from two search spaces, a single search space may not be able to accommodate the DCI transmission using aggregation level 4. This can lead to PDCCH blocking, preventing the UE from being scheduled, which may in turn waste control channel capacity and delay data transmission for the UE. The present disclosure provides technical solutions to this problem by creating an aggregated pool of fragmented control channel resources from plurality of search spaces. The base station can transmit configuration information to a UE that indicates an association between a first search space set and a second search space set for the purpose of CCE aggregation. Based on this association, the base station can then transmit a DCI within a PDCCH transmission that comprises a subset of CCEs aggregated from both the first and second search space sets. By logically combining the subset of CCEs of the linked search spaces, one or more aspects of the present disclosure may no longer be constrained by the CCE limits of any single search space. In the previously described scenario, the 2 CCEs from the first search space and the 2 CCEs from the second can be aggregated to form the 4 CCEs for the PDCCH transmission. A technical effect may include a reduction in PDCCH blocking probability by overcoming CCE fragmentation. This may improve the efficiency of the control signaling process, which can lead to more effective utilization of the radio spectrum, higher overall system throughput, and reduced scheduling latency.

Another example technical problem solved by aspects of the present disclosure may include the challenge of maintaining data reception integrity when control channel resources are aggregated across different time intervals. To maximize the pool of available CCEs and further reduce blocking, a base station may link search spaces that are in different transmission slots (e.g., inter-slot aggregation). However, this can introduce a timing desynchronization problem. The UE may be unable to fully decode the DCI until it has received the CCEs from the final slot in the aggregation sequence. In a system where the timing relationship between the control channel (e.g., PDCCH) and the data channel (e.g., PDSCH) is fixed, the UE could attempt to decode the PDSCH before it has successfully obtained the DCI. This premature decoding attempt could fail, leading to data loss, triggering retransmissions, and resulting in inefficient use of the UE's processing power and battery life. A communication protocol may lack a mechanism to dynamically inform the UE of a required delay for data reception caused by inter-slot CCE aggregation. The present disclosure provides technical solutions to this problem by establishing a dynamic timing relationship between the control and data channels. When the base station configures an inter-slot aggregation linkage between search spaces in different slots, it can also transmit an indication of a timing offset between the PDCCH candidate and its corresponding PDSCH. The UE can receive this offset and use it to adjust its PDSCH decoding timeline. Specifically, upon identifying a PDCCH candidate that spans multiple slots, the UE can understand that it may decode the PDSCH at a start time indicated by the timing offset, which can be configured to be after the completion of the last slot containing the aggregated CCEs. This combination of features can provide a mechanism for synchronizing data reception with a time-distributed control channel. A technical effect may include enabling more reliable data reception in conjunction with inter-slot CCE aggregation, which may prevent the decoding failures and resource wastage that could otherwise occur. This may improve system robustness and allow for greater scheduling flexibility, which may enhance the functioning and performance of the wireless communication protocol.

Another example technical problem solved by the present disclosure may include the ambiguity and increased complexity of searching for control information within an aggregated resource pool. When CCEs from multiple search spaces are logically combined, a conventional method for locating PDCCH candidates may become inadequate. The location of a PDCCH candidate can be found using a hash function that depends on the parameters of a single search space, such as its total number of CCEs. It can be unclear how this function might be applied to a combined pool, especially for a candidate that might span the boundary between the original search spaces. Furthermore, increasing the number of potential candidates for the UE to check can increase the number of blind decodes it performs. This can exceed the UE's processing capabilities and its configured blind decoding budget, leading to increased power consumption and potentially missed control information. A system may lack a coherent and efficient method for defining and locating PDCCH candidates within the aggregated CCE pool without overburdening the UE. The present disclosure provides technical solutions to this problem by creating a structured and efficient framework for candidate searching in an aggregated resource. An example solution may modify the control channel procedure such that a single, unified hash function can be applied to the entire aggregated plurality of CCEs to determine the location of a PDCCH candidate. This can allow candidates to be placed flexibly within the unified pool, which may maximize the benefit of aggregation. To manage complexity, the base station may transmit an indication of the specific number of PDCCH candidates that the UE needs to search for within this aggregated space, which facilitates that the total number of blind decodes performed by the UE does not exceed its configured maximum blind decoding budget. The UE, in turn, can apply the unified hash function to the aggregated CCEs to determine where to perform its blind decoding operations for the specified PDCCH candidates. A technical effect may be the creation of a deterministic method for both the base station to place and the UE to find PDCCH candidates in a logically combined resource pool, while also managing the computational load on the UE. The total aggregated CCEs from linked search spaces may not exceed the total number of CCEs that can be processed by a UE signaled using UE capability signaling. Alternatively, PDCCH can be transmitted using an aggregation level in by using subset of CCEs in a plurality of linked search spaces e.g., PDCCH using higher aggregation level can be transmitted using one or more smaller aggregation levels using subset of CCEs in a plurality of linked search spaces. This can improve the physical layer control signaling, which may make the communication protocol more robust and efficient.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Although aspects of an NR system may be described for purposes of example, and NR terminology may be used in much of the description, the techniques described herein are applicable beyond NR networks. For example, the described techniques may be applicable to various other wireless communications systems such as Institute of Electrical and Electronics Engineers (IEEE) 802.11 (Wi-Fi), IEEE 802.16 (WiMAX), as well as other systems and radio technologies not explicitly mentioned herein. Thus, the present disclosure is not limited to the examples and implementations described herein but is to be accorded the broadest scope consistent with the principles and novel features disclosed herein.

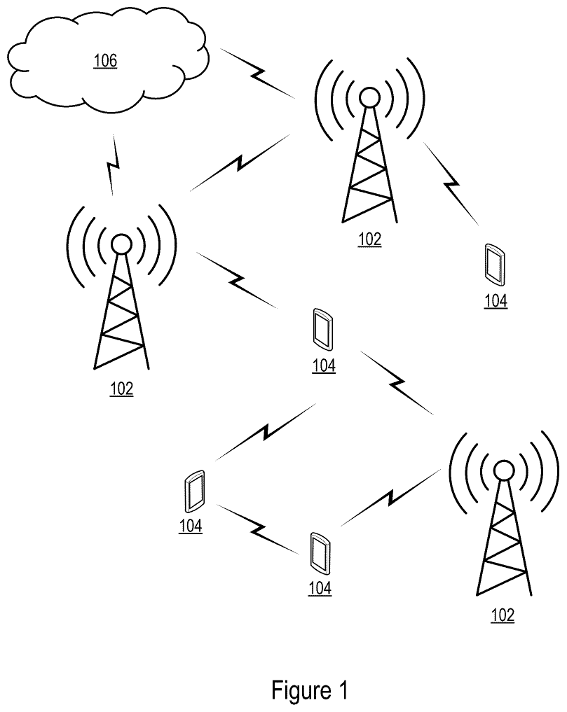

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a next-generation (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

In some implementations, an NE 102 may be implemented in a disaggregated architecture (e.g., a disaggregated base station architecture, a disaggregated RAN architecture), which may be configured to utilize a protocol stack that may be physically or logically distributed among multiple network entities (e.g., NEs 102), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), or any combination thereof. An RU may also be referred to as a radio head, a smart radio head, a remote radio head (RRH), a remote radio unit (RRU), or a transmission reception point (TRP). The split of functionality between a CU, a DU, and an RU may be flexible and may support different functionalities depending on which functions (e.g., network layer functions, protocol layer functions, baseband functions, RF functions, or any combinations thereof) are performed at a CU, a DU, or an RU.

One or more components of the NEs 102 in a disaggregated RAN architecture may be co-located, or one or more components of the NEs 102 may be located in distributed locations (e.g., separate physical locations). Additionally, or alternatively, in some examples, one or more of the NEs 102 of a disaggregated RAN architecture may be implemented as virtual units (e.g., a virtual CU (VCU), a virtual DU (VDU), a virtual RU (VRU)).

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

The wireless communications system 100 may be configured to support ultra-reliable communications or low-latency communications, or various combinations thereof. For example, the wireless communications system 100 may be configured to support ultra-reliable low-latency communications (URLLC). The UEs 104 may support ultra-reliable, low-latency, or critical functions. Ultra-reliable communications may include private communication or group communication. Support for ultra-reliable, low-latency functions may include prioritization of services, and such services may be used for public safety or general commercial applications. The terms ultra-reliable, low-latency, and ultra-reliable low-latency may be used interchangeably herein.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a CP. A first numerology (e.g., μ=0) may be associated with a first subcarrier spacing (e.g., 15 kHz) and a normal CP. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal CP. A third numerology (e.g., μ=2) may be associated with a third subcarrier spacing (e.g., 60 kHz) and a normal CP or an extended CP. A fourth numerology (e.g., μ=3) may be associated with a fourth subcarrier spacing (e.g., 120 kHz) and a normal CP. A fifth numerology (e.g., μ=4) may be associated with a fifth subcarrier spacing (e.g., 240 kHz) and a normal CP.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2,μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal CP, a slot may include 15 symbols. For an extended CP (e.g., applicable for 60 kHz subcarrier spacing), a slot may include 12 symbols. The relationship between the number of symbols per slot, the number of slots per subframe, and the number of slots per frame for a normal CP and an extended CP may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some implementations, specific hardware and signal processing adaptations can be performed for both the NE 102 and UE 104. For example, the NE 102 can include configurable processors and memory for mapping OCCs to PDCCHs per search space and per CCE, as well as logic to dynamically adapt resource multiplexing in real time. The UEs 104 are correspondingly configured to receive, buffer, and de-spread OCC-multiplexed PDCCH signals, recovering intended control information even in the presence of simultaneous transmissions. These improvements can directly address the practical bottleneck of CCE exhaustion, widen the bottleneck that prevents timely control signaling to numerous UEs 104, and thus yield a more scalable and reliable wireless communication infrastructure.

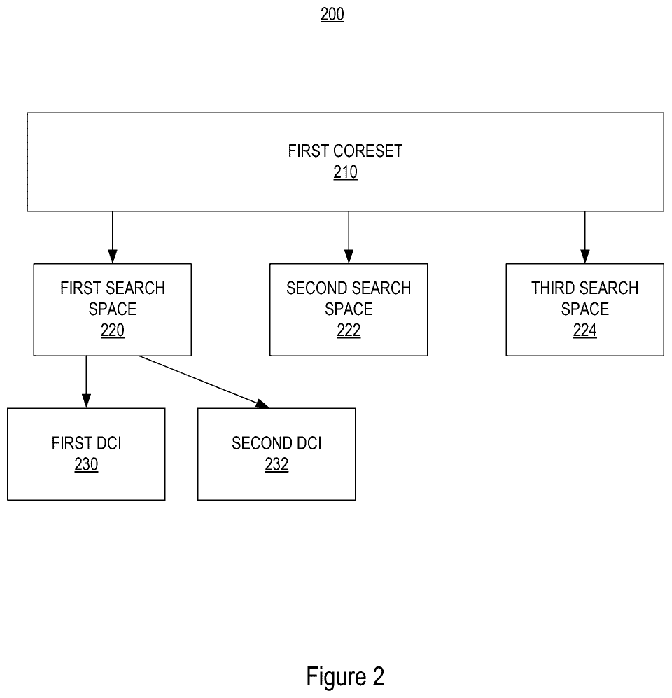

FIG. 2 illustrates an example mapping 200 of control resource allocation and signaling flow in accordance with aspects of the present disclosure. The mapping 200 indicates hierarchical structure and potential allocation of control resources and signaling in a 5G NR system implementation. In some examples, the mapping 200 may implement or be implemented by aspects of the wireless communications system 100. For example, the mapping 200 may be implemented by an NE 102 (e.g., a base station) and/or a UE 104, which may be an example of UEs 104 and NEs 102 as described with reference to FIG. 1.

In the example of FIG. 2, a first CORESET 210 may include one or more search spaces, such as a first search space 220, a second search space 222, and a third search space 224. An NE 102 may transmit, and a UE 104 may receive, one or more DCIs, such as a first DCI 230 and a second DCI 232. The first DCI 230 and the second DCI 232 can be mapped to one or more of the search spaces, such as the first search space 220.

The first CORESET 210 can include a configurable group of time-frequency resources designated for the transmission of PDCCHs. For example, the first CORESET 210 can encompass one or more resource blocks and OFDM symbols within a slot and can be defined by network configuration for either common or UE-specific usage. The first CORESET 210 can be constructed for multiple PDCCH transmissions for one or more UEs 104, and can support flexible mapping of search spaces and aggregation levels for different coverage or scheduling scenarios. In some implementations, the size, location, and structure of the first CORESET 210 can be configured by RRC signaling or via dynamic MAC messages according to current network requirements.

The first search space 220, the second search space 222, and the third search space 224, can each include a collection of CCE indices or candidate sets within the first CORESET 210. The first search space 220 and the second search space 222 can be linked by the NE 102 and can be associated with a first set of UEs 104. A plurality of linked search space can be configured for association with different types of control signaling or different UEs 104. For example, the first set of linked search spaces can represent a common search space for system information or paging, the second set of linked search spaces can correspond to a UE-specific search space for regular scheduling grants, and another set of linked search spaces can be another instance for signaling fallback or enhanced coverage information. In some implementations, a plurality of linked search space can be assigned distinct time-frequency patterns, aggregation levels, or monitoring occasions. Additionally, a plurality of linked search spaces can be mapped to the same or overlapping regions within the first CORESET 210, as described in some aspects of the disclosure.

The first DCI 230 can be associated with the first search space 220 and can be targeted at a first UE 104 or first set of UEs 104. For example, the first DCI 230 can carry scheduling assignments, resource grants, or control commands formatted in accordance with NR DCI standards, and mapped onto the CCEs indicated by the first search space 220. In some implementations, the first DCI 230 (e.g., first DCI codeword) can be transmitted in a time-frequency resource when sharing the first CORESET 210 with other search spaces, as can be configured by network signaling.

The second DCI 232 can be associated with the first search space 220 and can be targeted at a second UE 104 or second set of UEs 104. The second DCI 232 can provide resource scheduling information, system configuration updates, or slot-format indicators, formatted for the search parameters of the first search space 220. In some implementations, the second DCI 232 can be transmitted concurrently with the first DCI 230 within overlapping or distinct CCEs of the first CORESET 210, with orthogonal time-frequency resource applied as needed to support multiplexed signaling.

Additional branches, such as the connection to the second search space 222 indicate that further search spaces and corresponding DCI can be defined and associated with the first CORESET 210.

In some implementations, the NE 102 can dynamically configure or adaptively manage the number and characteristics of search spaces and DCIs per CORESET based on scheduling demand, UE capabilities, or specific service requirements. The dynamic configuration allows flexible support for control channel multiplexing, dynamic search space allocation, and orthogonal time-frequency resource separation within a common resource set in compliance with the described aspects of the present disclosure.

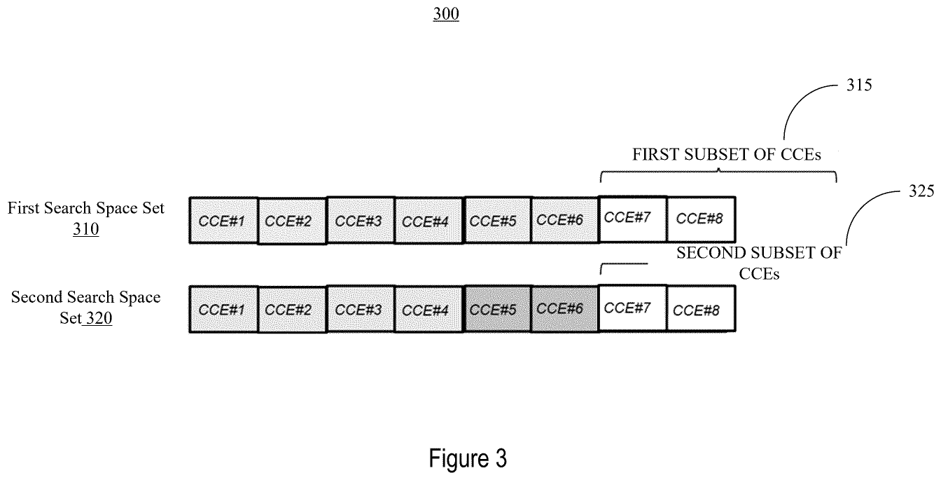

FIG. 3 illustrates a CCE mapping technique 300 in accordance with aspects of the present disclosure. FIG. 3 will be discussed in conjunction with FIG. 1.

In a first example implementation, a base station can be configured to schedule a UE that is associated with a PDCCH aggregation level of 4 (AL=4). Within a single transmission slot, a CORESET can contain two separate, non-overlapping search space sets: a first search space set 310 with a first subset of CCEs 315 (e.g., two unused CCEs) and a second search space set 320 with a second subset of CCEs 325 (e.g., two unused CCEs. In this conventional mapping technique, the UE can be blocked from scheduling a PDCCH with AL=4 needing 4 CCEs in a search space, as neither search space individually contains the 4 CCEs for the candidate.

In an example implementation as illustrated in FIG. 3, the base station can transmit configuration information to the UE, for example via a RRC message, which establishes an intra-slot aggregation linkage between the first and second search space sets. In one example, first search space is in the first OFDM symbol and the second search space is in the second OFDM symbol. A scheduler at the base station can aggregate the first subset of CCEs 315 from the first search space set 310 with the second subset of CCEs 325 from the second search space set 320 to form a logical PDCCH candidate of AL=4. The base station can transmit the DCI in this aggregated PDCCH candidate. The base station can also transmit an indication of a timing offset set to zero, which can signal that the corresponding PDSCH follows a standard timing. The UE, having received the configuration of usage of CCE aggregation in the linked search spaces, can perform blind decoding on the combined CCE resources to obtain the DCI. An outcome of this process may include a reduction in the likelihood of PDCCH blocking and more efficient utilization of previously fragmented CCE resources, which can allow the UE to be scheduled for data transmission and may improve overall control channel capacity.

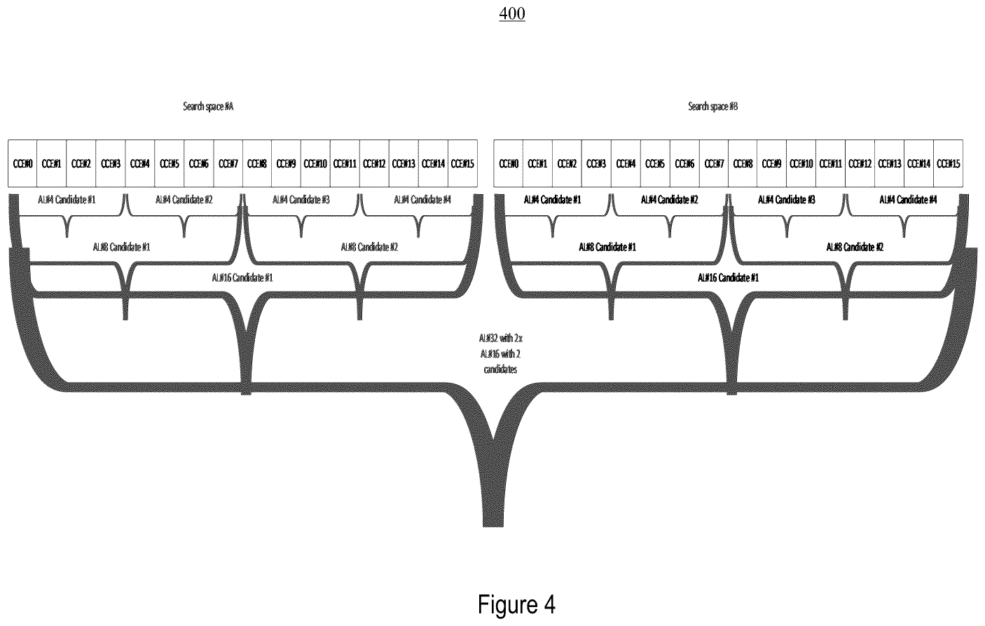

FIG. 4 illustrates a CCE aggregation technique 400 using a plurality of search spaces in accordance with aspects of the present disclosure. FIG. 4 will be discussed in conjunction with FIG. 1. As previously mentioned, aggregation level defines number of CCEs, thus an aggregation level 16 can equate to 16 CCEs. Aggregation levels and number of CCEs are interchangeably used in these examples and can have the same meaning.

In some instances, a UE or group of UEs can be configured to perform a CCE aggregation technique 400 as described in FIG. 4. In this process, the system uses a hash function to calculate the location of the DCI. The hash function can consider the total pool of CCEs available across multiple search space sets (rather than just one) to determine the starting CCE for a PDCCH candidate.

This aggregation of CCEs across search spaces can be implemented in two physical arrangements, which are interleaved or non-interleaved. In the interleaved arrangement, the CCEs can be shuffled or distributed. In the non-interleaved arrangement, the CCEs are contiguous.

Additionally, there can be a plurality of implementation scenarios. The aggregation of CCEs can occur at various time and/or frequency configurations. In the intra-slot scenario, the CCEs are aggregated from search spaces within the same CORESET ID inside a single time slot. In the inter-slot scenario, the CCEs are aggregated from search spaces that may belong to the same or different CORESETs across different time slots. In the span-based scenario, the CCEs are aggregated across a span, which can be a defined group of multiple slots).

The network explicitly informs the UE of these configurations, ensuring the device knows which search spaces are linked and how to monitor for these distributed PDCCH candidates.

In some instances, to achieve a high aggregation level (e.g., AL16) for reliability, the network may split the CCE resources into different linked search spaces. Instead of sending all 16 CCEs in one block, the base station can transmit 8 CCEs in Search Space A (SS #A) and 8 CCEs in Search Space B (SS #B).

The UE can decode the signal using a matching criteria. For the UE to successfully recombine these parts, the candidate CCE index can be identical across both search spaces, utilizing the same scrambling and the same Radio Network Temporary Identifier (RNTI).

In the decoding process, the UE detects the smaller segment (e.g., AL8) in the first search space using the first candidate e.g., candidate for AL8. The UE stores (e.g., buffers) these CCEs (rather than discarding them as incomplete). Additionally, the UE waits to receive the remaining CCEs from the second linked search space. It aggregates (e.g., multiplexes) the stored CCEs with the new CCEs to reconstruct the full target level (e.g., AL16). Finally, the UE decodes the complete PDCCH message. In this example, network may use the hash function with the number of CCEs configured in a CORESET to calculate the CCE index.

Furthermore, the system can have a plurality of configuration options for PDCCH candidates. In an explicit signaling option, the search spaces operate with their standard PDCCH candidates, and the base station explicitly signals additional specific candidates to be used for aggregation. In an implicit derivation option, the larger aggregation level is formed naturally by combining existing smaller candidates. For example, “Candidate #1 of AL8 in Set A”+“Candidate #1 of AL8 in Set B” automatically combine to form “Candidate #1 of AL16.” Additionally, a new PDCCH candidate can be configured dynamically from a partial or subset of number of CCEs of each search space that is part of a plurality of linked search spaces.

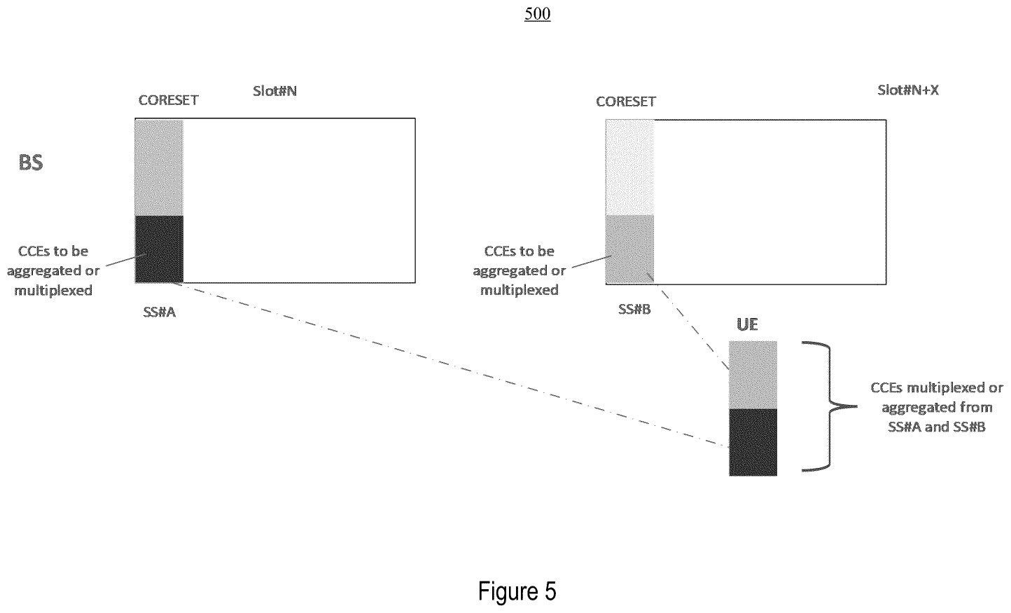

FIG. 5 illustrates a CCE aggregation technique 500 at a UE using a plurality of search spaces in accordance with aspects of the present disclosure. FIG. 5 will be discussed in conjunction with FIG. 1.

According to some examples, when a UE is configured to perform CCE aggregation across multiple search spaces, it can follow a specific retrieval process. The UE first retrieves the subset of CCEs from the configured linked search spaces (which may occur within the same slot or across different slots). Once all components are retrieved, the UE performs blind decoding on the fully aggregated set of CCEs to identify and decode the DCI.

The UE operates under specific monitoring budgets (e.g., a maximum number of blind decodes per slot or per span) which account for this aggregation overhead. To ensure successful processing, the network can adhere to specific timing offsets for downlink (e.g., PDSCH) scheduling and uplink (e.g., PUSCH) scheduling. When using cross-slot scheduling with linked search spaces, the time offset between the control channel (e.g., PDCCH) and the data channel (e.g., PDSCH) should be sufficient. Thus, the offset should be greater than or equal to the time difference between the two linked search space monitoring occasions.

For example, if the UE monitors the first part of the message (Search Space A) in Slot #1 and the second part (Search Space B) in Slot #3 (a difference of 2 slots), the PDSCH offset should be at least two to ensure that the UE has received the complete control message before the data arrives.

Similarly, for uplink grant, the offset should accommodate both the reception gap and the hardware processing time. The configured offset should be greater than: the time difference (in slots) between the linked search space occasions plus the standard PUSCH preparation time.

For example, the UE retrieves the total aggregated CCEs, decodes the uplink grant, and then utilizes the remaining time in the offset to prepare the PUSCH transmission.

In one implementation, one or more aspects of the present disclosure ensures that the CCEs selected for aggregation are non-overlapping (i.e., they use distinct physical resources) across the search spaces or search space sets.

Additionally, the UE can report a capability parameter defining the maximum slot difference that the UE can support between linked search spaces. If the network schedules two linked search spaces with a gap larger than this reported maximum, the UE may skip monitoring the second search space and discard any CCEs that were stored from the first search space. Similarly, the concept of CCE aggregation can be extended to the frequency domain by aggregating CCEs from one or more search spaces or search space set belonging to a plurality of CORESETs in different carriers or BWPs or a combination thereof. The search space or search space set can be linked from plurality of CORESETs in different carriers or BWPs or a combination thereof. In one instance, number of CCEs in each CORESET within a BWP or a carrier or a combination thereof can be aggregated in the frequency domain thereby increasing the total pool of CCEs and determination of CCE index can be performed using such larger pool of CCEs from CORESET aggregation or multiplexing. In another instance, PDCCH may be transmitted using a larger aggregation level by using subset of CCEs from each linked search space or search space sets from plurality of CORESETs in different carriers or BWPs or a combination thereof in the frequency domain using the existing candidate position of smaller aggregation levels, thereby one advantage with the frequency domain, is that the UE capable and/or configured to receive multiple frequency domain BWPs or carriers or a combination thereof can combine subset of CCEs in the frequency domain similar to the time domain method within the same slot. In another instance, BS may configure a combination of time and frequency domain CCE aggregation or multiplexing techniques to schedule PDCCH.

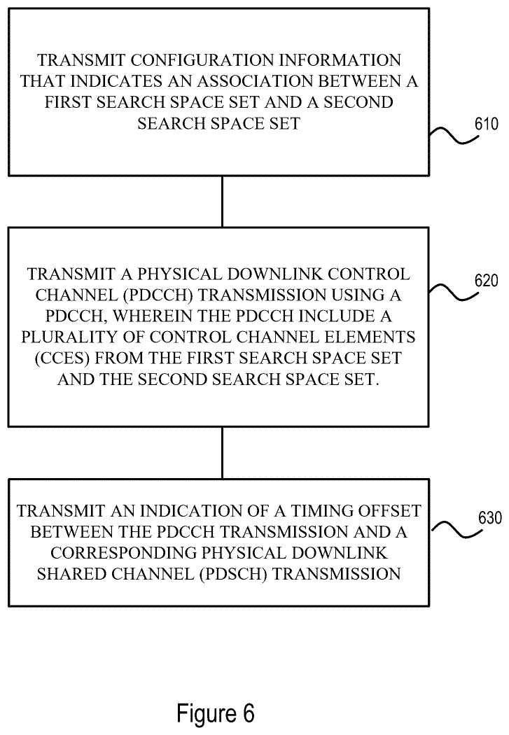

FIG. 6 illustrates a flowchart of a method in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

In an example implementation, a base station can be configured to schedule a UE, such as a UE located at a cell edge, that is associated with a high aggregation level of 16 (AL=16) for DCI reception. A scheduler can determine that in a current slot, Slot N, a maximum of 8 CCEs are available in a first search space set, and in a subsequent slot, Slot N+1, another 8 CCEs are available in a second search space set. To facilitate scheduling, the base station can transmit configuration information to the UE that indicates an inter-slot aggregation linkage between the first search space set in Slot N and the second search space set in Slot N+1. The base station scheduler can then allocate the 8 CCEs in Slot N and the 8 CCEs in Slot N+1 to form a single logical PDCCH candidate of AL=16. The base station can transmit the encoded DCI over this two-slot candidate. To improve the likelihood of correct data reception, the base station can also transmit an indication of a non-zero timing offset. This offset can instruct the UE to delay the start of its PDSCH decoding until a time after the completion of Slot N+1. The UE can receive signals corresponding to the first 8 CCEs in Slot N, buffer them, and then combine them with the signals from the 8 CCEs in Slot N+1 to perform a blind decode on the full AL=16 candidate. Upon decoding the DCI, the UE can apply the timing offset to decode the PDSCH at the later, indicated start time. An outcome can include the scheduling of a UE that might otherwise be blocked and the prevention of PDSCH decoding failures and retransmissions, which may improve service coverage and system robustness.

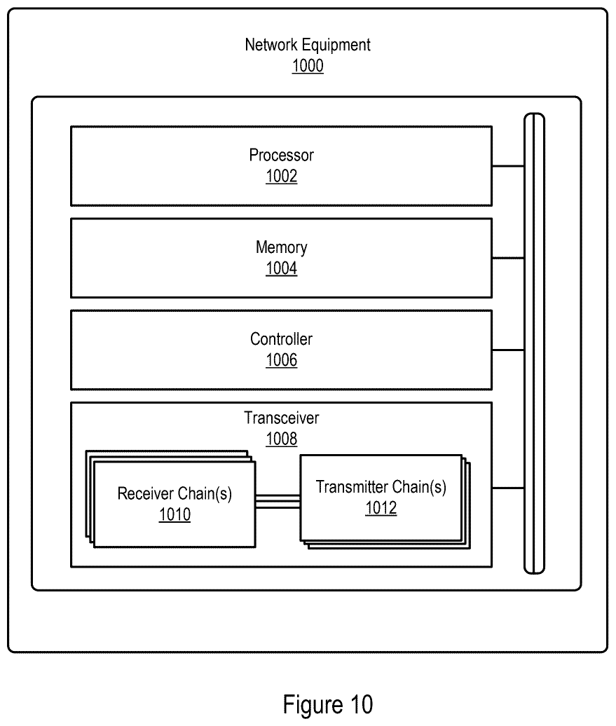

At operation 610, the method may include transmitting configuration information that indicates an association between a first search space set and a second search space set. The configuration information can be transmitted to a UE. The operations of 610 may be performed in accordance with examples as described herein. In some implementations, aspects of the operations of 610 may be performed by a NE as described with reference to FIG. 10.

In some instances, the configuration information identifies the plurality of CCEs from the first search space set and the second search space set.

In some instances, the plurality of CCEs can include a first subset of CCEs from the first search space set and a second subset of CCEs from the second search space set.

In some instances, the association between the first search space set and the second search space set can correspond to an intra-slot aggregation linkage. In the intra-slot aggregation linkage, the first search space set and the second search space set are in a same slot (e.g., time slot). Additionally, in the intra-slot aggregation linkage, the timing offset can be set to zero.

In some instances, the association between the first search space set and the second search space set can correspond to an inter-slot aggregation linkage. In the inter-slot aggregation linkage, the first search space set and the second search space set can be in different slots. Additionally, in the inter-slot aggregation linkage, the timing offset can be set to an integer number associated with the different slots.

In some instances, the association between the first search space set and the second search space set can correspond to a per-span aggregation linkage, wherein span defines a number of slots. In the per-span aggregation, the first search space set and second search space set can be within a span of multiple slots. Additionally, the timing offset can be based on multiple slots within a span. The timing offset defines the timing offset or gap between the reception of plurality of linked search spaces (e.g., first search space and second search space).

In some instances, the first search space set and the second search space set are associated with a same CORESET identifier.

Alternatively, in some instances, the first search space set and the second search space set are associated with a different CORESET identifier. For example, different CORESETs may be configured with different beamforming or QCL-D assumptions. For example, the first search space can be configured with a different beamforming or QCL-D assumptions than the second search space.

In one example, a first CCE from the first search space set and a second CCE from the second search space set are aggregated using a non-interleaved mapping to obtain the plurality of CCEs. In another example, a first CCE from the first search space set and a second CCE from the second search space set are aggregated using an interleaved mapping to obtain the plurality of CCEs. In yet another example, a first CCE from the first search space set and a second CCE from the second search space set are aggregated using a partial or selective interleaved mapping to obtain the plurality of CCEs.

In one example, a first CCE from the first search space set and a second CCE from the second search space set are aggregated or multiplexed using a non-interleaved mapping to obtain the plurality of CCEs. In another example, a first CCE from the first search space set and a second CCE from the second search space set are aggregated using an interleaved mapping to obtain the plurality of CCEs. In yet another example, a first CCE from the first search space set and a second CCE from the second search space set are aggregated using a partial or selective interleaved mapping to obtain the plurality of CCEs for the transmission of PDCCH using a selected aggregation level.

In some instances, the plurality of CCEs includes a first CCE from the first search space set and a second CCE from the second search space set.

At operation 620, the method may include transmitting a PDCCH transmission using a PDCCH. The PDCCH can include a plurality of CCEs from the first search space set and the second search space set. The operations of 630 may be performed in accordance with examples as described herein. In some implementations, aspects of the operations of 610 may be performed by a NE as described with reference to FIG. 10.

In some instances, the plurality of CCEs can include a first subset of CCEs from the first search space set and a second subset of CCEs from the second search space set.

In some instances, the plurality of CCEs in a search space can be determined semi-statically and the configuration information on the search space identifier or search space set identifier linkage can be transmitted in a RRC message. Additionally, the configuration information may include a field to provide information on whether a subset of CCEs in each search space can be aggregated, multiplexed, or repeated to transmit a PDCCH within linked search space or search space set.

In some instances, the plurality of CCEs can be determined dynamically. Additionally, the configuration information can be transmitted during the PDCCH transmission. In one example, the DCI payload that is transmitted in the PDCCH transmission can include the configuration information.

At operation 630, the method may include transmitting an indication of a timing offset between the PDCCH transmission and a corresponding PDSCH transmission. The operations of 610 may be performed in accordance with examples as described herein. In some implementations, aspects of the operations of 630 may be performed by a NE as described with reference to FIG. 10.

In some instances, the method can further include calculating, using a hash function, a CCE index based on the plurality of CCEs.

In some instances, the base station can transmit an indication of a specific number of PDCCH candidates in a search space (e.g., first search space).

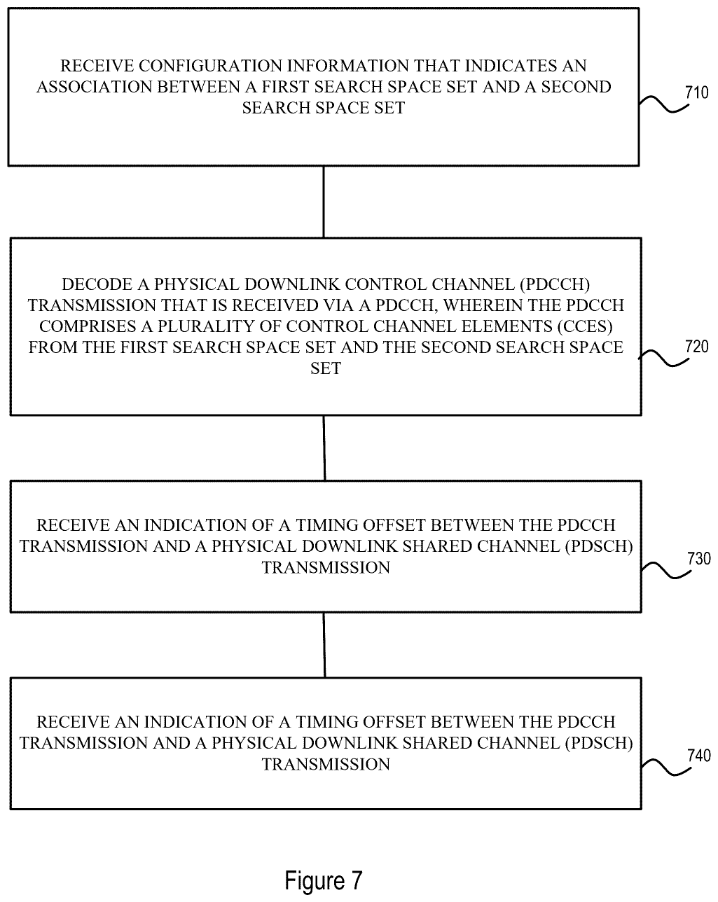

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

On the receiver side, the UE can be configured to receive and decode PDCCH transmissions by performing de-spreading and separation of the different control channels assigned to the search spaces. For example, in challenging coverage scenarios, the CORESET used for PDCCH transmission can be repeated. This repetition helps UEs in poor radio conditions to better decode the PDCCH by increasing signal energy and enabling improved channel estimation. The UE can then perform blind decoding or other control channel search procedures on the separated control information corresponding to its configured search spaces.

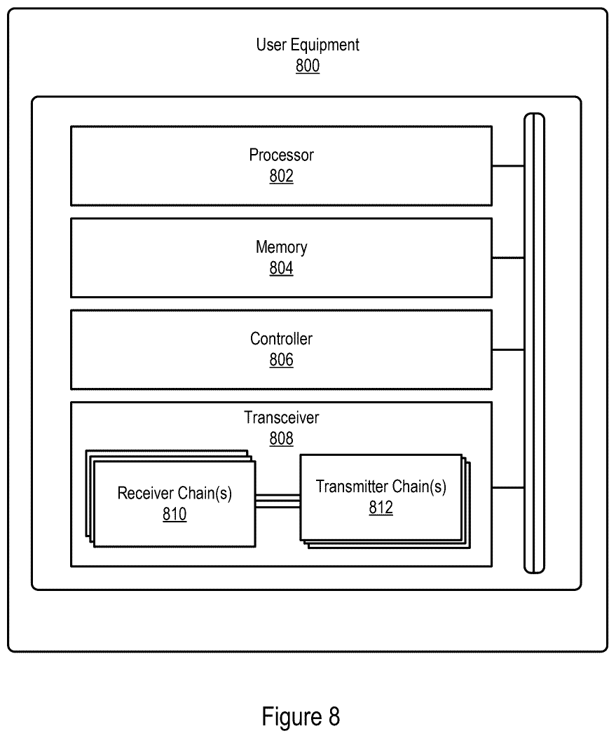

At operation 710, the method may include receiving configuration information that indicates an association between a first search space set and a second search space set. The operations of 710 may be performed in accordance with examples as described herein. In some implementations, aspects of the operations of 710 may be performed by a UE as described in reference to FIG. 8.

At operation 720, the method may include decoding a PDCCH transmission that is received via a PDCCH. The PDCCH can include a plurality of CCEs from the first search space set and the second search space set. The operations of 720 may be performed in accordance with examples as described herein. In some implementations, aspects of the operations of 720 may be performed by a UE as described with reference to FIG. 8.

In some instances, the PDCCH transmission contains DCI associated with a selected aggregation level. For example, the UE can decode a PDCCH transmission containing DCI using a selected aggregation level that is received via a PDCCH.

At operation 730, the method can include receiving an indication of a timing offset between the PDCCH transmission and a PDSCH transmission. The operations of 720 may be performed in accordance with examples as described herein. In some implementations, aspects of the operations of 720 may be performed by a UE as described with reference to FIG. 8.

At operation 740, the method can include decoding the PDSCH transmission based on the timing offset. The operations of 720 may be performed in accordance with examples as described herein. In some implementations, aspects of the operations of 720 may be performed by a UE as described with reference to FIG. 8.

In some instances, the method can include adjusting a PDSCH decoding timeline based on the timing offset.

In some instances, the configuration information identifies the plurality of CCEs from the first search space set and the second search space set. Additionally, the plurality of CCEs can include a first subset of CCEs from the first search space set and a second subset of CCEs from the second search space set.

In some instances, the method can include receiving an indication of a specific number of PDCCH candidates. Additionally, the method can include determining a location of a PDCCH candidate for decoding the PDCCH transmission based on using a hash function and the plurality of CCEs.

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to support a means for receiving configuration information, the configuration information indicates that a first search space and a second search space are mapped to a first CORESET spanning a first set of time-frequency resources corresponding to a PDCCH that carries a plurality of PDCCH symbols, and wherein the configuration information includes an orthogonal code for multiplexing a first PDCCH symbol that is transmitted in the first search space; receiving, based on monitoring the first search space, the first PDCCH symbol; and decoding, using the orthogonal code, the first PDCCH symbol.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

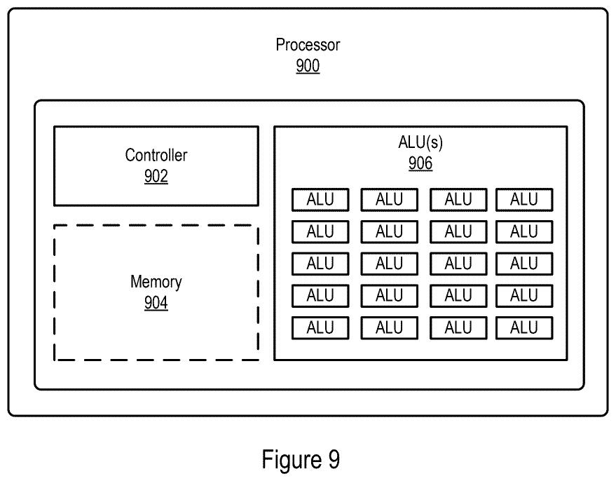

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support a means for mapping a first search space and a second search space to a first CORESET spanning a first set of time-frequency resources corresponding to a PDCCH that carries a plurality of PDCCH symbols; orthogonal time-frequency multiplexing, a first PDCCH symbol and a second PDCCH symbol, wherein the first PDCCH symbol is to be transmitted in the first search space of the first CORESET and the second PDCCH symbol is to be transmitted in the second search space of the first CORESET; transmitting, using the first search space of the first CORESET, the first PDCCH symbol to a first set of UEs configured to monitor the first search space; and transmitting, using the second search space of the first CORESET, the second PDCCH symbol to a second set of UEs configured to monitor the second search space.

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for mapping a first search space and a second search space to a first CORESET spanning a first set of time-frequency resources corresponding to a physical downlink control channel (PDCCH) that carries a plurality of PDCCH symbols; orthogonal time-frequency multiplexing,, a first PDCCH symbol and a second PDCCH symbol, wherein the first PDCCH symbol is to be transmitted in the first search space of the first CORESET and the second PDCCH symbol is to be transmitted in the second search space of the first CORESET; transmitting, using the first search space of the first CORESET, the first PDCCH symbol to a first set of UEs configured to monitor the first search space; and transmitting, using the second search space of the first CORESET, the second PDCCH symbol to a second set of UEs configured to monitor the second search space.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding the processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

Aspects of the present disclosure are described in the context of a wireless communications system. Additional details of one or more implementations of the present disclosure are set forth in the accompanying drawings and the description below. Other aspects and advantages will become apparent from the description, the drawings, and the claims.

The following provides an overview of aspects of the present disclosure:

Example 1 relates to a method for wireless communication. The method can be performed by a base station. The method can include transmitting configuration information that indicates an association between a first search space set and a second search space set. Additionally, the method can include transmitting a PDCCH transmission using a PDCCH, wherein the PDCCH comprises a plurality of CCEs from the first search space set and the second search space set. Moreover, the method can include transmitting an indication of a timing offset between the PDCCH transmission and a corresponding PDSCH transmission.

Example 2 includes the method of example 1. In this example, the PDCCH transmission contains DCI associated with a selected aggregation level.

Example 3 includes the method of examples 1 or 2. In this example, the configuration information identifies the plurality of CCEs from the first search space set and the second search space set, and wherein the plurality of CCEs includes a first subset of CCEs from the first search space set and a second subset of CCEs from the second search space set.

Example 4 includes the method of any of the examples 1 to 3. In this example, the association between the first search space set and the second search space set corresponds to an intra-slot aggregation linkage, wherein the first search space set and the second search space set are in a same slot, and wherein the timing offset is set to zero.

Example 5 includes the method of any of the examples 1 to 4. In this example, the association between the first search space set and the second search space set corresponds to an inter-slot aggregation linkage, wherein the first search space set and the second search space set are in different slots, and wherein the timing offset is set to an integer number associated with the different slots.

Example 6 includes the method of any of the examples 1 to 5. In this example, the association between the first search space set and the second search space set corresponds to a per-span aggregation linkage, where the first search space set and second search space set are within a span of multiple slots, and wherein the timing offset is associated with a gap between the reception of the first search space and the second search space.

Example 7 includes the method of any of the examples 1 to 6. In this example, wherein the first search space set and the second search space set are associated with a same CORESET identifier.

Example 8 includes the method of any of the examples 1 to 7. In this example, the first search space set and the second search space set are associated with a different CORESET identifier.

Example 9 includes the method of any of the examples 1 to 8. In this example, the plurality of CCEs is determined statically, and wherein the configuration information is transmitted in an RRC message.

Example 10 includes the method of any of the examples 1 to 9. In this example, the plurality of CCEs is determined dynamically, and wherein the configuration information is transmitted during the PDCCH transmission.

Example 11 includes the method of any of the examples 1 to 10. In this example, a first CCE from the first search space set and a second CCE from the second search space set are aggregated using a non-interleaved mapping to obtain the plurality of CCEs.

Example 12 includes the method of any of the examples 1 to 11. In this example, a first CCE from the first search space set and a second CCE from the second search space set are aggregated using an interleaved mapping to obtain the plurality of CCEs.

Example 13 includes the method of any of the examples 1 to 12. In this example, a first CCE from the first search space set and a second CCE from the second search space set are aggregated using a partial or selective interleaved mapping to obtain the plurality of CCEs for the PDCCH transmission associated with a selected aggregation level.

Example 14 includes the method of any of the examples 1 to 13. In this example, the plurality of CCEs includes a first CCE from the first search space set and a second CCE from the second search space set, and wherein DCI is transmitted in the first CCE and in the second CCE, and wherein the DCI is associated with a selected aggregation level.

Example 15 includes the method of any of the examples 1 to 14. In this example, the method further includes transmitting an indication of a specific number of PDCCH candidates in the first search space set.

Example 16 relates to a base station for wireless communication. The base station can include one or more memories; and one or more processors coupled with the one or more memories and individually or collectively operable to cause the base station to perform the method described in any of the examples 1 to 15.

Example 17 relates to a processor comprising at least one controller coupled with at least one memory and configured to cause the processor to perform the method described in any of the examples 1 to 15.

Example 18 relates to a method for wireless communication. The method can be performed by a UE. The method can include receiving configuration information that indicates an association between a first search space set and a second search space set. Additionally, the method can include decoding a PDCCH transmission that is received via a PDCCH, wherein the PDCCH comprises a plurality of CCEs from the first search space set and the second search space set. Moreover, the method can include receiving an indication of a timing offset between the PDCCH transmission and a PDSCH transmission. Furthermore, the method can include decoding the PDSCH transmission based on the timing offset.

Example 19 includes the method of example 18. In this example, the PDCCH transmission contains DCI associated with a selected aggregation level.

Example 20 includes the method of example 18 or example 19. In this example, the configuration information identifies the plurality of CCEs from the first search space set and the second search space set, and wherein the plurality of CCEs includes a first subset of CCEs from the first search space set and a second subset of CCEs from the second search space set.

Example 21 includes the method of any of the examples 18 to 20. In this example, the method can receive an indication of a specific number of PDCCH candidates. Additionally, the method can determine a location of a PDCCH candidate for decoding the PDCCH transmission based on using a hash function and the plurality of CCEs.

Example 22 relates to a UE for wireless communication. The UE can include one or more memories; and one or more processors coupled with the one or more memories and individually or collectively operable to cause the UE to perform the method described in any of the examples 18 to 21.

Example 23 relates to a processor comprising at least one controller coupled with at least one memory and configured to cause the processor to perform the method described in any of the examples 18 to 21.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

As used herein, including the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, a “set” may include one or more elements.

The description provided herein, along with the accompanying figures, illustrates certain example implementations and is not intended to encompass all possible implementations within the scope of the claims. As used herein, the term “example” is intended to convey an illustration or instance, and does not imply a preferred or superior implementation. The detailed description includes specific features and elements to facilitate understanding of the implementations described in the present disclosure. However, these implementations may also be realized without some or all of the specified details.

What is claimed is:

1. A base station for wireless communication, comprising:
one or more memories; and
one or more processors coupled with the one or more memories and individually or collectively operable to cause the base station to:
transmit configuration information that indicates an association between a first search space set and a second search space set;
transmit a Physical Downlink Control Channel (PDCCH) transmission using a PDCCH, wherein the PDCCH comprises a plurality of control channel elements (CCEs) from the first search space set and the second search space set; and
transmit an indication of a timing offset between the PDCCH transmission and a corresponding Physical Downlink Shared Channel (PDSCH) transmission.

2. The base station of claim 1, wherein the PDCCH transmission contains downlink control information (DCI) associated with a selected aggregation level.

3. The base station of claim 1, wherein the configuration information identifies the plurality of CCEs from the first search space set and the second search space set, and wherein the plurality of CCEs includes a first subset of CCEs from the first search space set and a second subset of CCEs from the second search space set.

4. The base station of claim 1, wherein the association between the first search space set and the second search space set corresponds to an intra-slot aggregation linkage, wherein the first search space set and the second search space set are in a same slot, and wherein the timing offset is set to zero.

5. The base station of claim 1, wherein the association between the first search space set and the second search space set corresponds to an inter-slot aggregation linkage, wherein the first search space set and the second search space set are in different slots, and wherein the timing offset is set to an integer number associated with the different slots.

6. The base station of claim 1, wherein the association between the first search space set and the second search space set corresponds to a per-span aggregation linkage, and wherein the first search space set and the second search space set are within a span of multiple slots, and wherein the timing offset is associated with a gap between the first search space set and the second search space set.

7. The base station of claim 1, wherein the first search space set and the second search space set are associated with a same Control Resource Set (CORESET) identifier.

8. The base station of claim 1, wherein the first search space set and the second search space set are associated with a different CORESET identifier.

9. The base station of claim 1, wherein the plurality of CCEs is determined semi-statically, and wherein the configuration information is transmitted in a Radio Resource Control (RRC) message.

10. The base station of claim 1, wherein the plurality of CCEs is determined dynamically, and wherein the configuration information is transmitted during the PDCCH transmission.

11. The base station of claim 1, wherein a first CCE from the first search space set and a second CCE from the second search space set are aggregated using a non-interleaved mapping to obtain the plurality of CCEs.

12. The base station of claim 1, wherein a first CCE from the first search space set and a second CCE from the second search space set are aggregated using an interleaved mapping to obtain the plurality of CCEs.

13. The base station of claim 1, wherein a first CCE from the first search space set and a second CCE from the second search space set are aggregated using a partial or selective interleaved mapping to obtain the plurality of CCEs for the PDCCH transmission associated with a selected aggregation level.

14. The base station of claim 1, wherein the plurality of CCEs includes a first CCE from the first search space set and a second CCE from the second search space set, and wherein DCI is transmitted in the first CCE and in the second CCE, and wherein the DCI is associated with a selected aggregation level.

15. The base station of claim 1, wherein the one or more processors are further operable to cause the base station to:
transmit an indication of a specific number of PDCCH candidates in the first search space set.

16. A method performed or performable by a base station, the method comprising:
transmitting configuration information that indicates an association between a first search space set and a second search space set;
transmitting a Physical Downlink Control Channel (PDCCH) transmission using a PDCCH, wherein the PDCCH comprises a plurality of CCEs from the first search space set and the second search space set; and
transmitting an indication of a timing offset between the PDCCH transmission and a corresponding Physical Downlink Shared Channel (PDSCH) transmission.

17. A User Equipment (UE) for wireless communication, comprising:
one or more processors; and
one or more memories coupled with the one or more processors and storing instructions that, when executed, cause the UE to:
receive configuration information that indicates an association between a first search space set and a second search space set;
decode a Physical Downlink Control Channel (PDCCH) transmission that is received via a PDCCH, wherein the PDCCH comprises a plurality of control channel elements (CCEs) from the first search space set and the second search space set;
receive an indication of a timing offset between the PDCCH transmission and a Physical Downlink Shared Channel (PDSCH) transmission; and
decode the PDSCH transmission based on the timing offset.

18. The UE of claim 17, wherein the PDCCH transmission contains downlink control information (DCI) associated with a selected aggregation level.

19. The UE of claim 17, wherein the configuration information identifies the plurality of CCEs from the first search space set and the second search space set, and wherein the plurality of CCEs includes a first subset of CCEs from the first search space set and a second subset of CCEs from the second search space set.

20. The UE of claim 17, wherein the one or more processors are further operable to cause the UE to:
receive an indication of a specific number of PDCCH candidates; and
determine a location of a PDCCH candidate for decoding the PDCCH transmission based on using a hash function and the plurality of CCEs.
